(19) United States
(12) Patent Application Publication
(10) Pub. No.: US 2012/0256018 A1
(43) Pub. Date: Oct. 11, 2012

(54) ROTATING NOZZLE SYSTEM

(76) Inventor: Hermann LANGE, Metzingen (DE)

(21) Appl. No.: 13/428,082

(22) Filed: Mar. 23, 2012

(30) Foreign Application Priority Data
Apr. 6, 2011 (DE) 102011006865.1

(51) Int. Cl. B05B 15/08

(52) U.S. Cl. 239/587.1

(57) ABSTRACT

A rotating nozzle system including a housing that is immovable in relation to a connected feed pipe and to a rotating nozzle head, wherein the nozzle head has at least one outlet orifice and wherein the nozzle head is connected to a shaft protruding into the housing and is non-rotatably connected to a turbine wheel present within the housing. The turbine wheel and the shaft each have a center through bore for the purpose of providing, within the housing, a first flow path extending from the connected feed pipe to the nozzle head and passing through the turbine wheel and a second flow path extending from the connected feed pipe to the nozzle head and passing through each of the center bores.

### CROSS REFERENCE TO RELATED APPLICATION

This application claims the priority of German Application No. 10 2011 006 865.1, filed Apr. 6, 2011, the disclosure of which is hereby incorporated by reference in its entirety into this application.

### FIELD OF THE INVENTION

The invention relates to a rotating nozzle system comprising a housing that is immovable in relation to a connected feed pipe and a rotating nozzle head, wherein the nozzle head comprises at least one outlet orifice and wherein the nozzle head is connected to a shaft that protrudes into the housing and that is non-rotatably connected to a turbine wheel disposed within the housing.

### BACKGROUND OF THE INVENTION

The European patent specification EP 0 645 191 B1 discloses a rotating nozzle system in which an immovable housing and a rotating nozzle head are provided. The housing comprises a swirl insert and a turbine wheel that is rigidly coupled to the shaft. In order to prevent the shaft from rotating at increasingly higher speeds when the water pressure rises, there is provided a friction brake between the shaft and the housing, which friction brake is controlled by fluid pressure and effects an increased braking action when the water pressure rises. The friction brake controlled by fluid pressure is in the form of a thrust bearing. When the fluid pressure rises, the shaft is forced against the axial bearing surface of the thrust bearing with increasing force and thus produces an increased frictional force.

### SUMMARY OF THE INVENTION

The object of the invention is to provide an improved rotating nozzle system.

To this end, there is provided, according to the invention, a rotating nozzle system that comprises a housing that is immovable in relation to a connected feed pipe and a rotating nozzle head, wherein the nozzle head comprises at least one outlet orifice and wherein the nozzle head is connected non-rotatably to a shaft that protrudes into the housing and that is non-rotatably connected to a turbine wheel disposed within the housing, wherein the turbine wheel and the shaft each have a center through bore for the purpose of providing a first flow path leading, within the housing, from the connected feed pipe to the nozzle head via the turbine wheel and a second flow path leading, within the housing, from the connected feed pipe to the nozzle head via each of the said center bores.

These measures provide a nozzle system that rotates slowly and in a controlled manner, since not all of the liquid flowing from the connected feed pipe is guided through the turbine wheel, but rather, a portion of the liquid is guided along the flow path that leads through the said center bores and that thus does not pass through the turbine wheel and is hence a non-contributive factor to the rotation of the nozzle head. Thus the speed of rotation of the nozzle head does not continuously increase as the water pressure rises but instead remains within a comparatively narrow speed range. Thus the rotating nozzle system of the invention is designed with no friction brake controlled by fluid pressure in order to keep the speed of rotation of the nozzle head within a defined range as the water pressure rises. The provision of a second flow path not constituting a contributive factor to the rotation of the nozzle head on account of it being centrally located, makes it possible to achieve a controlled speed characteristic when the water pressure rises. The omission of a friction brake makes it possible to design the nozzle system of the invention so as to be wear-resistant.

In a development of the invention, a swirl insert is provided within the housing upstream of the turbine wheel, which swirl insert is provided with a center through bore.

A more effective inflow of liquid into the turbine wheel can be achieved by the provision of a swirl insert. The swirl insert also has a center through bore for the purpose of providing the second flow path not passing through the turbine wheel and is thus a non-contributive factor to the rotation of the nozzle head. The swirl insert is immovable in relation to the housing and is provided, for example, with flow passages that are disposed obliquely in relation to the longitudinal center axis of the nozzle system and, more particularly, that are in the form of bores disposed obliquely in a disk.

In a development of the invention, the shaft comprises a collar that is located within the housing and that protrudes outwardly in the radial direction and that forms a bearing surface of a thrust bearing, which shaft is provided with at least one radial bore directly downstream of the collar, which radial bore opens into a bearing gap next to the bearing surface of the collar.

In this way, liquid flowing through the center bore of the shaft can be forced against the bearing surface of the thrust bearing immediately after pressure is applied to the nozzle system. When pressure is applied to the nozzle system, the axial bearing is thus immediately lubricated by liquid and is substantially no longer subjected to friction. This makes it possible to realize a substantially wear-resistant design of the thrust bearing and to use materials such as PTFE (Teflon) that intrinsically wear down rapidly when subjected to dry friction. Thus the rotating nozzle system of the invention can be provided with bearing materials that are specified for use in, for example, the food processing industry and yet it can be designed so as to be highly wear-resistant.

In a development of the invention, the bearing surface of the collar is juxtaposed to a radial bearing surface of the shaft. In this way, a combined axial/radial bearing can be provided, in which liquid flowing from the radial bore in the shaft is forced against both the axial bearing surface and the radial bearing surface as soon as pressure is applied to the nozzle system. Thus both the axial bearing and the radial bearing are liquid-lubricated and are substantially free from friction on the application of pressure to the nozzle system.

In a development of the invention, the housing is provided with a bearing bush that forms a bearing surface of the thrust bearing and a bearing surface of the radial bearing, and the bearing bush comprises a lubricating pocket that is disposed in the bearing surface of the radial bearing juxtaposed to the bearing surface of the thrust bearing and that extends around the periphery of the bearing bush and that is in fluid communication with the radial bore in the shaft.

These measures can ensure that liquid flowing from the center bore of the shaft is forced very rapidly and reliably against the bearing surfaces of the thrust bearing and the radial bearing. Thus the combined thrust and radial bearing formed by the bearing bush does not act as a friction brake controlled by liquid pressure but instead provides a liquid film in the thrust bearing and the radial bearing immediately on application of pressure to the nozzle system to effect substantially frictionless operation irrespective of the existing liquid pressure.

In a development of the invention, the turbine wheel is provided with a centrally disposed bearing component.

In this way, the shaft can be mounted at the location at which it enters the housing and at the turbine wheel and is thus mounted within the housing. For example, a spigot or a bush is provided on the turbine wheel for this purpose. Since the bearing component on the turbine wheel is located within the housing, it is inevitably attacked by the flow of liquid and it is thus constantly liquid-lubricated and substantially free from friction.

In a development of the invention, a swirl insert is provided upstream of the turbine wheel within the housing, which swirl insert comprises a centrally disposed bearing component adapted to cooperate with the bearing component on the turbine wheel.

In this way, the turbine wheel can be mounted on the swirl insert that is immovable in relation to the housing. Thus the nozzle system of the invention requires only a few components.

In a development of the invention, the bearing component on the swirl insert is in the form of a bearing spigot that extends into the bearing component on the turbine wheel which is in the form of a bearing bush. The spigot is provided with a center through bore.

This makes it possible to mount the turbine wheel within the housing and also to provide a second flow path not passing through the turbine wheel.

In a development of the invention, the shaft is provided with at least one radial bore downstream of the turbine wheel and within the housing for the purpose of guiding the liquid flowing through the turbine wheel into the center bore of the shaft.

In this way, low flow resistance of the nozzle system of the invention is achieved. For example, a plurality of radial bores is provided in the shaft downstream of the turbine wheel.

In a development of the invention, the turbine wheel comprises at least one driving bore that extends obliquely in relation to the longitudinal center axis of the nozzle system and that comprises at least one flared portion at its inflow end, which flared portion extends in the peripheral direction of the driving bore.

By means of such flared or convex portions of the driving bores it is possible to achieve an improved inflow of liquid into the turbine wheel and a more effective transfer of the energy of the liquid flowing through the swirl insert to the turbine wheel. Furthermore, the provision of such flared or convex portions at the inflow end of the driving bores may cause reduction of the axial thrust acting on the turbine wheel. This also facilitates the start-up of the turbine wheel at low operating pressures. The flared or convex portions can be formed, for example, by re-inserting the end milling cutter already used for creating the driving bores into the upstream region of the driving bores at a different angle of attack, that is to say, at an angle that is not, or less, inclined in relation to the longitudinal center axis. This results in a one-sided, funnel-like flare located at the inflow end of the driving bore. Such a flared portion can be provided at both ends of the driving bore as regarded in the peripheral direction of the turbine wheel.

Additional features and advantages of the invention are revealed in the claims and the following description of a preferred embodiment of the invention with reference to the drawings, in which:

### BRIEF DESCRIPTION OF THE DRAWINGS

FIG. 1 is a partially cross-sectional view of a rotating nozzle system of the invention,

FIG. 2 is an exploded view of the nozzle system shown in FIG. 1,

FIG. 3 shows the turbine wheel and the shaft of the nozzle system shown in FIG. 1 in a view taken obliquely from above,

FIG. 4 shows the turbine wheel and the shaft shown in FIG. 3 in a view taken obliquely from the side,

FIG. 5 is a top view of the turbine wheel and the shaft shown in FIG. 3,

FIG. 6 is a view taken along the sectional plane A-A shown in FIG. 5,

FIG. 7 is a view of the swirl insert of the nozzle system shown in FIG. 1 in a view taken obliquely from above, and

FIG. 8 is a partially cross-sectional view of the swirl insert and the turbine wheel of the nozzle system shown in FIG. 1.

### DETAILED DESCRIPTION

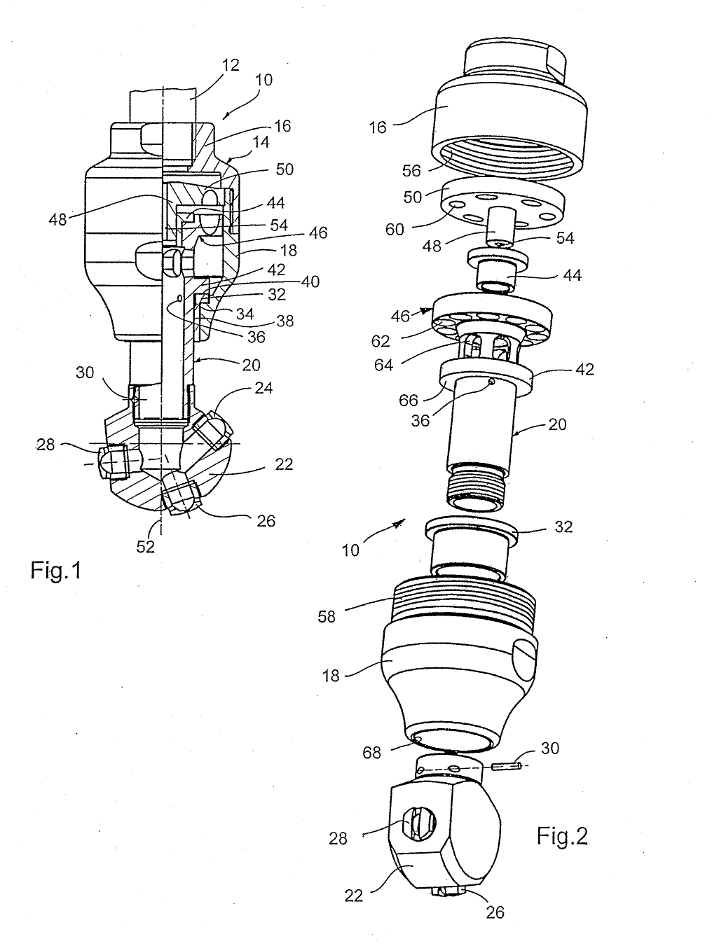

The illustration shown in FIG. 1 is a partially cross-sectional view of a rotating nozzle system 10 of the invention. The nozzle system 10 comprises a housing 14 that is immovable relative to a connected feed pipe 12, shown merely diagrammatically, and that is composed of a top half 16 and a bottom half 18. The connected feed pipe 12 is screwed into the top half 16 of the housing 14. The bottom half 18 is screwed to the top half 16.

A shaft 20 is mounted for rotation in the housing 14, and there is provided a nozzle head 22 comprising a total of three individual nozzles 24, 26, and 28 on the free end of the shaft 20 remote from the housing 14. Each of the nozzles 24, 26, 28 defines an outlet orifice through which the liquid to be atomized is discharged. The nozzles 24, 26, 28 are each in the form of fan nozzles, see also FIG. 2, and thus produce a fan-shaped spray that covers substantially 360° in the drawing plane of FIG. 1. Thus the nozzle system 10 can be used, for example, as a tank-cleaning nozzle.

The nozzle head 22 is screwed onto the free end of the shaft 20 and secured in position on the shaft 20 by means of a locking spigot 30.

The shaft 20 protrudes into the housing 14 and is mounted for rotation in the housing 14 by means of a bearing bush 32 made of, say, Teflon. The bearing bush 32 is provided on its internal surface facing the shaft 20 with a lubricating pocket 34 that extends around the periphery of the bearing bush 32 and that is in fluid communication with a radial bore 36 in the shaft 20. When liquid is present in the connected feed pipe 12 under pressure, it is forced through the radial bore 36 in the shaft 20 and into the lubricating pocket 34. From the peripherally extending lubricating pocket 34 the liquid is forced into a radial bearing gap 38 and an axial bearing gap 40. The radial bearing gap 38 is disposed between an internal radial bearing surface of the bearing bush 32 and the periphery of the shaft 20. The axial bearing gap 40 is disposed between an axial bearing surface of the bearing bush 32 shown in an upward position in FIG. 1 and an axial bearing surface, shown in a downward position FIG. 1, of a radial collar 42 on the shaft 20 located within the housing 14. Both the radial bearing gap 38 and the axial bearing gap 40 are supplied with liquid immediately after liquid has flowed from the connected feed pipe 12 into the interior of the shaft 20. Thus both the axial bearing surface and the radial bearing surface are liquid-lubricated, and the shaft 20 is thus mounted substantially free from friction in the bearing bush 32.

Furthermore, the shaft 20 is mounted in the housing 14 by means of an additional bearing bush 44 that is provided in a turbine wheel 46 which is an integral part of the shaft 20. The bearing bush 44 accommodates a bearing spigot 48 of a swirl insert 50 that is rigidly attached to the housing 14. A radial bearing for the shaft 20 and the turbine wheel 46 is formed by the bearing spigot 48 on the swirl insert 50 and the bearing bush 44, respectively.

The swirl insert 50 is clamped between the top half 16 and the bottom half 18 of the housing 14 and is thus attached to the housing 14.

The fan nozzles 24, 26, 28 in the nozzle head 22 are oriented in a neutral direction so that the spray jets discharged thereby are not conducive to either an increase or a decrease in the speed of rotation produced by the turbine wheel 46. The fan-shaped sprays discharged by the fan nozzles 24, 26, 28 are thus located in a plane, or are symmetrically disposed relative to a plane, which plane includes the longitudinal center axis 52 of the nozzle system 10. The discharge of a fan-shaped spray by the fan nozzles 24, 26, 28 does not therefore result in a torque about the longitudinal center axis 52. Of course, nozzles of an arbitrary kind may, within the scope of the invention, be used in place of fan nozzles 24, 26, 28.

In the case of the nozzle system 10, measures have been taken to prevent an excessive increase in the speed of rotation of the nozzle head 22 about the longitudinal center axis 52 when the water pressure increases. Apart from a first flow path leading from the connected feed pipe 12 through the swirl insert 50 and the turbine wheel 46 and thence back into the interior of the through-bored shaft 20 and to the nozzle head 22, there is provided a second flow path that leads from the connected feed pipe 12 through a center bore 54 in the swirl insert directly into the interior of the shaft 20 and thence to the nozzle head 22. Liquid passing along this second flow path does not flow through the turbine wheel 46 and is thus a non-contributive factor to the rotational movement of the nozzle head 22. The provision of this second flow path by-passing the turbine wheel 46 will ensure that the speed of rotation of the nozzle head 22 is not increased or is increased only within narrow limits when the water pressure in the connected feed pipe 12 increases. The essential feature in this context is that there is no requirement for a friction brake controlled by fluid pressure for limiting the speed of rotation of the nozzle head 22 and also of the turbine wheel 46 when the water pressure increases. Thus the nozzle system 10 and, more specifically, the bearings comprising the bearing bushes 44, 32 can be of a highly wear-resistant design. Thus the shaft 20 is bored through end-to-end concentrically relative to the longitudinal center axis, and the swirl insert 50 has a center bore 54 that opens into the interior of the shaft 20. Thus liquid can flow from the connected feed pipe through the center bore 54 directly into the interior of the shaft 20 and thus to the fan nozzles 24, 26, 28 on the nozzle head 22.

FIG. 2 is an exploded view of the nozzle system 10 shown in FIG. 1. The top half 16 of the housing is provided with a female thread 56 into which a male thread 58 on the bottom half 18 of the housing can be screwed. As explained with reference to FIG. 1, the swirl insert 50 is thereby clamped securely between the two halves 16, 18 of the housing. The swirl insert 50 comprises a total of six swirl bores 60 that are uniformly inclined in the peripheral direction of the swirl insert. Thus pressurized liquid present above the swirl insert 50 is obliquely diverted by the swirl bores such that it strikes the turbine wheel 46 and thus causes the turbine wheel 46 to rotate about the longitudinal center axis 52.

The swirl insert 50 is provided with a bearing spigot 48 that has a through bore 54 concentrically disposed relative to the longitudinal center axis 52. The bearing spigot 48 protrudes into the bearing bush 44. The bearing bush 44 comprises a cylindrical portion and a collar that extends around the periphery of the bearing bush 44 and that is accommodated in a complementary recess in the top face of the turbine wheel 46.

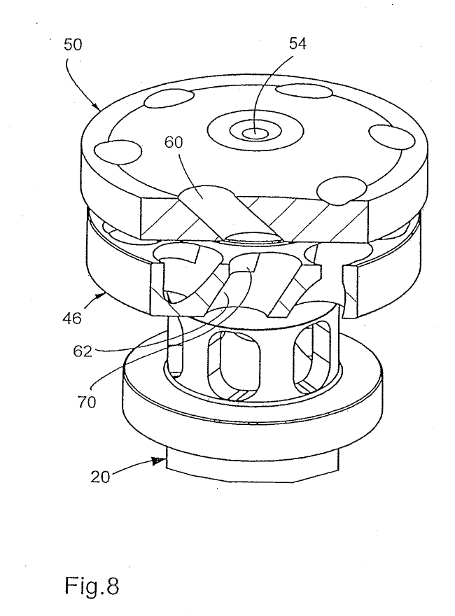

The turbine wheel 46 is provided with a total of ten driving holes 62, which are inclined in relation to the longitudinal center axis 52. The angle of inclination of the driving bores 62 is oriented in the opposite direction to that of the swirl bores 60, as may be seen in FIG. 8, for example.

The turbine wheel 46 is an integral part of the through-bored shaft 20 and it likewise comprises a center bore into which the bearing bush 44 is inserted.

The shaft 20 is provided with a total of six radially disposed elongated holes 64 on its region adjoining the turbine wheel 46. The direction of extension of the elongated holes is parallel to the longitudinal center axis 52. Liquid that has passed through the driving bores 62 in the turbine wheel 46 can flow through the elongated holes 64 into the interior of the through-bored shaft 20 and thence to the nozzle head 22. Thus a first flow path for liquid coming from the connected feed pipe 12 leads through the swirl bores 60 disposed in the swirl insert 50, through the driving bores 62 disposed in the turbine wheel 46 and thence through the elongated holes 64 into the interior of the through-bored shaft 20 and thence into the nozzle head 22 and to the fan nozzles 24, 26, 28. A second flow path leads, as mentioned above, through the center bore 54 of the swirl insert 50 and thence directly into the interior of the through-bored shaft 20 and thence likewise to the nozzle head 22 and the fan nozzles 24, 26, 28.

On that side of the elongated holes 64 which is opposed to the turbine wheel 46, the shaft 20 is provided with the collar 42 which extends in the radial direction and around the periphery of the shaft 20 and of which the underside remote from the turbine wheel forms an axial bearing surface 66 of a thrust bearing. The shaft 20 is pushed into the bearing bush 32 that likewise comprises a collar which extends in the radial direction and extends around the periphery of the bearing bush 32 and whose top face forms an axial bearing surface. A cylindrical portion of the bearing bush 32 is pushed into a bearing bore 68 disposed in the bottom half 18 of the housing. The peripherally extending collar 42 forms with its bearing surface 66 and the top face of the bearing bush 32 a thrust bearing for the shaft 20 that absorbs forces directed downwardly, as depicted in FIG. 1, and parallel to the longitudinal center axis 52. As mentioned above, the radial bore 36 in the shaft 20 and the lubricating pocket 34 disposed in the bearing bush 32, as shown in FIG. 1, ensure that the radial bearing gap 38 and the axial bearing gap 40 between the shaft 20 and the bearing bush 32 are liquid-lubricated once pressure is applied to the connected feed pipe 12, such that the thrust bearing and the radial bearing are substantially friction-free.

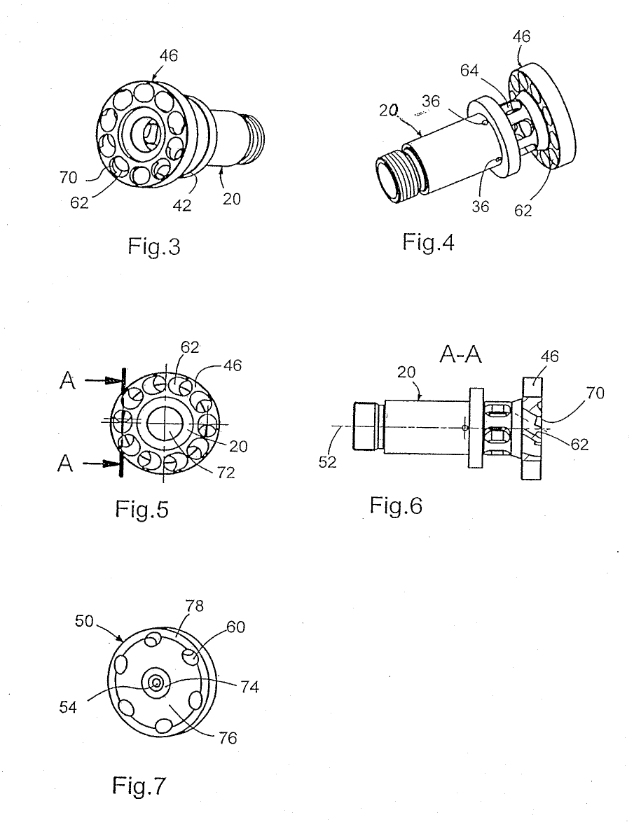

The illustration shown in FIG. 3 shows the shaft 20 and the turbine wheel 46 in a view taken obliquely from above. It can be seen that the driving bores 62 are formed in the disk-shaped turbine wheel 46 so as to be inclined toward the longitudinal center axis in the peripheral direction. Furthermore, all of the driving bores 62 have a flared portion 70 extending in the peripheral direction. The flared portion 70 is produced by re-inserting an end milling cutter, which has already been driven at an angle into the disk-shaped turbine wheel 46 for the purpose of creating the driving bores 62, into the top region of the driving bores 62 at a different angle of attack or, for example, in a direction extending parallel to the longitudinal center axis. An improved flow of liquid into the turbine wheel 46 can be achieved by means of such flared portions or convex portions 70 of the driving bores 62, and the energy of the liquid flowing through the swirl insert 50 can be transferred more effectively to the turbine wheel 46. The flared portions 70 and their arrangement relative to the swirl insert 50 can also be seen clearly in the illustration shown in FIG. 8.

The illustration shown in FIG. 4 depicts the shaft 20 and the turbine wheel 46 in a view taken obliquely from the side. A total of four radial bores 36, of which only two are visible in FIG. 2, are provided in the shaft 20 below the peripherally extending collar 42. As explained above, these radial bores 36 ensure that the thrust bearing and the radial bearing between the shaft 20 and the bearing bush 32 are lubricated by the liquid, see FIG. 1.

The illustration shown in FIG. 5 is a top view of the turbine wheel 46 and the through-bored shaft 20. The figure clearly shows the internal chamber 72, which extends throughout the through-bored shaft 20 and through which liquid can flow directly from the connected feed pipe through the center bore 54 of the swirl insert 50 and through the driving bores 62 of the turbine wheel 46 and the elongated holes 64 to the nozzle head 22, see FIG. 1.

The illustration shown in FIG. 6 is a cross-sectional view taken along the sectional plane A-A shown in FIG. 5. The driving bores 62 extending obliquely relative to the longitudinal center axis 52 and the flared portions 70 disposed at the upstream end of the driving bores 62 are clearly visible in FIG. 6.

The illustration shown in FIG. 7 shows the swirl insert 50 in a view taken obliquely from above. The center bore 54 is disposed concentrically to the generally disk-shaped swirl insert 50 and is located at the base of a depression 74 that is likewise disposed concentrically to the swirl insert 50. The top face of the swirl insert 50 is slightly convex, see FIG. 1. The swirl bores 60 are disposed in the region of the transition between the convex portion 76 and an outer disk-shaped portion 78 of the swirl insert 50.

The illustration shown in FIG. 8 is an enlarged partially cross-sectional view of the swirl insert 50 and the turbine wheel 46 and a portion of the shaft 20. It can be seen that the swirl bores 60 in the swirl insert 50 are inclined in the opposite direction to that of the driving bores 62 in the turbine wheel 46. When the turbine wheel is viewed in the peripheral direction, it can be seen that the flared portions 70 of the driving bores 62 in the turbine wheel 46 are disposed only on one side of the driving bores 62. The flared portions 70 disposed at the upstream end of the driving bores 62 ensure an easier start-up of the turbine wheel 46, since the full cross-section of the liquid jet discharged from the swirl bores 60 can enter the driving bores 62 when the driving bores 62 are disposed approximately in the position shown in FIG. 8 in relation to the swirl bores 60. This ensures not only that the turbine wheel 46 starts running at low operating pressures, but also that the energy of the liquid jets flowing through the swirl bores 60 is transferred more effectively to the turbine wheel 46 during operation. Start-up of the turbine wheel 46 is also facilitated in that an axial thrust acting on the turbine wheel 46 in a direction extending parallel to the longitudinal center axis 52 is less than which would have been the case, had the flared portions 70 not been provided.

During operation of the nozzles, liquid present above the swirl insert 50 will pass, on the one hand, through the swirl bores 60 and, on the other hand, through the center bore 54. The center bore 54 has the positive effect of reducing the turbulence of flow within the internal chamber of the shaft 20 such that the fan nozzles 24, 26, 28 will have a more pronounced spray pattern. This substantially improves the cleaning action of the fan-shaped spray discharged by the fan nozzles 24, 26, 28 and their range of throw. As explained above, the center bore 54 also ensures that the hollow shaft 20 will rotate uniformly at increasing fluid pressures.

Furthermore, the center bore 54 in the swirl insert 50 also ensures that any particles present in the liquid supplied are guided directly into the internal chamber of the shaft 20 and thus to the fan nozzles 24, 26, 28 and that these particles cannot pass into the bearing gap between the bearing spigot 48 on the swirl insert 50 and the bearing bush 44 on the turbine wheel 46 or into the radial bearing gap 38 or the axial bearing gap 40 between the bearing bush 32 and the shaft 20, see FIG. 1.

1. A rotating nozzle system comprising a housing that is immovable in relation to a connected feed pipe and to a rotating nozzle head, wherein said nozzle head has at least one outlet orifice and wherein said nozzle head is connected to a shaft protruding into said housing and non-rotatably connected to a turbine wheel present within said housing, wherein said turbine wheel and said shaft each have a center through bore for the purpose of providing, within said housing, a first flow path extending from said connected feed pipe to said nozzle head and passing through said turbine wheel and a second flow path extending from said connected feed pipe to said nozzle head and passing through each of said center bores.

2. The nozzle system as defined in claim 1, wherein said housing there is provided a swirl insert upstream of said turbine wheel, wherein said swirl insert is provided with a center through bore.

3. The nozzle system as defined in claim 1, wherein said shaft has, within said housing, a radially outwardly protruding collar, which forms a bearing surface of an axial thrust bearing, wherein said shaft is provided with at least one radial bore directly downstream of said collar.

4. The nozzle system as defined in claim 3, wherein said bearing surface of said collar is juxtaposed to a radial bearing surface of said shaft.

5. The nozzle system as defined in claim 4, wherein said housing is provided with a bearing bush, which forms a bearing surface of said axial thrust bearing and a bearing surface of said radial bearing, wherein said bearing bush has a peripheral lubricating pocket and wherein said lubricating pocket is in fluid communication with at least one radial bore in said shaft.

6. The nozzle system as defined in claim 1, wherein said turbine wheel is provided with a centrally disposed bearing component.

7. The nozzle system as defined in claim 6, wherein a swirl insert is provided within said housing upstream of said turbine wheel, wherein said swirl insert has a centrally disposed bearing component adapted to cooperate with said bearing component on said turbine wheel.

8. The nozzle system as defined in claim 7, wherein said bearing component on said swirl insert is in the form of a spigot adapted to mate with said bearing component on said turbine wheel, which is in the form of a bearing bush.

9. The nozzle system as defined in claim 8, wherein said spigot is provided with a center through bore.

10. The nozzle system as defined in claim 1, wherein said shaft is provided, downstream of said turbine wheel and within said housing, with at least one radial bore for the purpose of guiding liquid passing through said turbine wheel into said center bore in said shaft.

11. The nozzle system as defined in claim 1, wherein said turbine wheel has at least one driving bore, which is oriented obliquely toward the longitudinal center axis of said nozzle system and which has at least one flared portion at its inflow end, which flared portion extends in the peripheral direction.
